(19) United States
(12) Patent Application Publication
(10) Pub. No.: US 2024/0355487 A1
(43) Pub. Date: Oct. 24, 2024

(54) Fuel Assembly for Sodium-Cooled Metal Fuel Fast Reactor, Reactor Core, and Manufacturing Method of Fuel Assembly

(71) Applicant: Hitachi-GE Nuclear Energy, Ltd., Ibaraki (JP)

(72) Inventors: Kouji FUJIMURA, Tokyo (JP); Junichi MIWA, Tokyo (JP)

(21) Appl. No.: 18/636,378

(22) Filed: Apr. 16, 2024

(30) Foreign Application Priority Data
Apr. 19, 2023 (JP) 2023-068445

(51) Int. Cl. G21C 3/326; G21C 1/02; G21C 3/60; G21C 21/02

(52) U.S. Cl. CPC G21C 3/326; G21C 1/02; G21C 3/60; G21C 21/02

(57) ABSTRACT

Provided are a fuel assembly for a sodium-cooled metal fuel fast reactor, a reactor core, and a manufacturing method of the fuel assembly. Compared with conventional techniques, the fuel assembly and the reactor core can subject more MA to nuclear transmutation by allowing to increase the weight of MA to be loaded in the reactor core. One or more of an upper axial blanket fuel or lower axial blanket fuel in an inner core fuel assembly or outer core fuel assembly, or a radial blanket fuel in a radial blanket fuel assembly is a U—Pu-MA-Zr alloy of a low Pu enrichment lower in Pu enrichment than a core fuel, and has a MA enrichment and a Pu enrichment satisfying a relationship of 0 wt %<MA enrichment≤Pu enrichment.

### CROSS-REFERENCE TO RELATED APPLICATION

The present application claims priority from Japanese application JP2023-068445, filed on Apr. 19, 2023, the content of which is hereby incorporated by reference into this application.

### BACKGROUND OF THE INVENTION

### 1. Field of the Invention

The present invention relates to a fuel assembly for a sodium-cooled metal fuel fast reactor, a reactor core, and a manufacturing method of the fuel assembly. The fuel assembly and the reactor core increase the nuclear transmutation amount of minor actinides (MA), and hence contribute to a reduction in the toxicity of radioactive waste and rationalization of geological disposal sites.

### 2. Description of the Related Art

Patent Document 1 describes that a fuel element with a metal fuel, which contains MA, enclosed in a fuel cladding tube has a fuel material region of a two-layer configuration formed from a metal fuel in a central portion in a transverse plane and another metal fuel in an outer peripheral portion surrounding the metal fuel in the central portion in the transverse plane, the metal fuel in the central portion in the transverse plane is a rod-shaped fuel having a high minor actinide content, the metal fuel in the outer peripheral portion is a particulate or cylindrical metal fuel having a low minor actinide content or containing no minor actinide, and the fuel element includes a gas plenum region defined by an inner surface of the fuel cladding tube between a porous intermediate end plug and a porous lower end plug.

### PRIOR ART DOCUMENT

### Patent Document

Patent Document 1: JP-2017-26372-A

### SUMMARY OF THE INVENTION

Generally, in a fast breeder reactor, a core is arranged in a reactor vessel, and liquid sodium as a coolant is filled in the reactor vessel. Fuel assemblies loaded in the core each have a plurality of fuel rods with plutonium-enriched depleted uranium (U-238) encased therein, a wrapper tube surrounding a bundle of the fuel rods, an entrance nozzle supporting lower end portions of these fuel rods and a neutron shield located below the fuel rods, and a coolant outlet portion located above the fuel rods.

The core of the fast breeder reactor includes a core fuel region having an inner core region and an outer core region surrounding the inner core region, a blanket fuel region surrounding the core fuel region, and a shield region surrounding the blanket fuel region.

In the case of a standard homogeneous core, fuel assemblies loaded in an outer core region have a plutonium (Pu) enrichment higher than that of fuel assemblies loaded in an inner core region. As a result, the power distribution in a radial direction of the core is flattened.

Types of nuclear fuel material contained in each fuel rod of a fuel assembly include a metal fuel, a nitride fuel, and an oxide fuel. Of these, an oxide fuel has achieved the most wide-spread utility. Pellets of a mixed oxide fuel in which respective oxides of Pu and depleted uranium are mixed, specifically, pellets of a mixed oxide (MOX) fuel are enclosed to a height of approximately 80 to 100 cm in a central portion in an axial direction of the fuel rod. In the fuel rod, axial blanket regions, which are each filled with a plurality of uranium dioxide pellets made of depleted uranium, are also arranged above and below an enclosing region of MOX fuel, respectively, in a vertical direction.

The inner core fuel assemblies loaded in the inner core region and the outer core fuel assemblies loaded in the outer core region each have the fuel rods filled with the pellets of MOX fuel. The Pu enrichment of the outer core fuel assemblies is higher than that of the inner core fuel assemblies.

In the blanket fuel region surrounding the core fuel region, blanket fuel assemblies are loaded, each of which has a plurality of fuel rods filled with a plurality of uranium dioxide pellets made of depleted uranium.

Among neutrons generated through a nuclear fission reaction occurred in the fuel assemblies loaded in the core fuel region, those which leaked from the core fuel region are absorbed by U-238 in the individual fuel rods of the blanket fuel assemblies loaded in the blanket fuel region. As a result, Pu-239, which is a fissile nuclide, is newly created in the individual fuel rods of the blanket fuel assemblies.

Upon startup and shutdown of the fast breeder reactor and upon control of reactor power, control rods are used. Each control rod has a plurality of neutron absorber rods with boron carbide (B₄C) pellets enclosed in a cladding tube made from stainless steel, and is formed by holding these neutron absorber rods in a wrapper tube having a regular hexagonal shape in a transverse plane like the inner core fuel assemblies and the outer core fuel assemblies. The control rods are in an independent dual-system configuration of a main reactor shutdown system and a backup reactor shutdown system, and an emergency shutdown of the fast breeder reactor is possible by only one of the main reactor shutdown system and the backup reactor shutdown system. Now among high-level radioactive wastes (HLW) that occur through reprocessing of a spent fuel from nuclear reactors, MA such as americium (Am) and curium (Cm) retain radioactivity for long time.

Research is under way to rationalize geological disposal sites and hence to ensure a reduction in environmental burden through a reduction in the toxicity of HLW and a reduction in decay heat in several hundred years by partitioning and recovering such MA from HLW and subjecting them to nuclear transmutation in a fast reactor. As an example of such techniques, there is the technique as described in Patent Document 1.

Here, to realize further rationalization of geological disposal sites through nuclear transmutation of MA, which are contained in HLW occurring through reprocessing of a spent fuel from light-water reactors, by using a sodium-cooled metal fuel fast reactor, there is a need to ensure an increase in nuclear transmutation amount by further increasing MA, which is to be loaded in the reactor core, within an upper limit of void reactivity.

The present invention has as objects thereof the provision of a fuel assembly for a sodium-cooled metal fuel fast reactor, a reactor core, and a manufacturing method of the fuel assembly. The fuel assembly and the reactor core can subject more MA to nuclear transmutation by increasing the weight of MA, which is to be loaded in the reactor core, compared with the conventional techniques.

The present invention includes a plurality of means for achieving the objects. An example can be a core fuel assembly or a radial blanket fuel assembly among fuel assemblies for a sodium-cooled fast reactor using a metal fuel. One or more of an axial blanket fuel in the core fuel assembly or a radial blanket fuel in the radial blanket fuel assembly is a U—Pu-MA-Zr alloy of a low Pu enrichment lower in Pu enrichment than a core fuel, and has a MA enrichment and a Pu enrichment satisfying a relationship of 0 wt %<MA enrichment≤ Pu enrichment.

According to the present invention, more MA can be subjected to nuclear transmutation by increasing the weight of MA, which is to be loaded in a reactor core, compared with the conventional techniques. Objects, configurations, and effects other than those described above will become more apparent by the following description of Examples.

### BRIEF DESCRIPTION OF THE DRAWINGS

FIG. 1 is a horizontal cross-sectional view of half a core of a fast reactor of Example 1;

FIG. 2 is a horizontal cross-sectional view of a core fuel assembly in the fast reactor of Example 1;

FIG. 3 is a horizontal cross-sectional view of a radial blanket fuel assembly in the fast reactor of Example 1;

FIG. 4 is a longitudinal cross-sectional view of the core fuel assembly in the fast reactor of Example 1;

FIG. 5 is a longitudinal cross-sectional view of a radial blanket fuel assembly in the fast reactor of Example 1;

FIG. 6 is a longitudinal cross-sectional view of a core in the fast reactor of Example 1;

FIG. 7 is a diagram illustrating a relationship between a Pu enrichment and an MA enrichment in a fast reactor of Example 2;

FIG. 8 is a longitudinal cross-sectional view of a core in a fast reactor of Example 3; and

FIG. 9 is a longitudinal cross-sectional view of an inner core fuel assembly in the fast reactor of Example 3.

### DESCRIPTION OF THE PREFERRED EMBODIMENTS

Examples of the fuel assembly for the sodium-cooled metal fuel fast reactor, the reactor core, and the manufacturing method of the fuel assembly, all according to the present invention, will hereinafter be described using the drawings. It is to be noted that in the drawings used herein, the same or corresponding elements are identified by the same or similar reference numerals, and their repeated descriptions may be omitted.

### Example 1

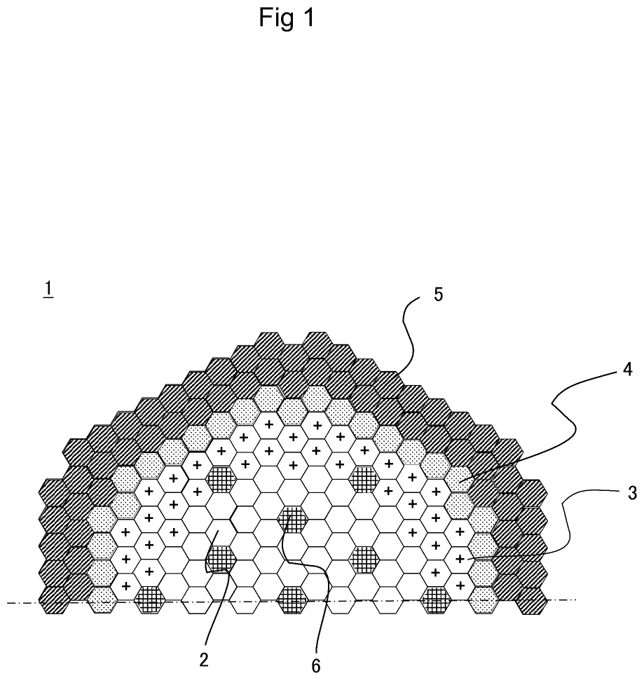

Fuel assemblies for the sodium-cooled metal fuel fast reactor, a reactor core, and a manufacturing method of the fuel assemblies, all in Example 1, will be described using FIGS. 1 through 6.

Using FIG. 1, a description will first be made about an outline of the core of the sodium-cooled metal fuel fast reactor. FIG. 1 is a view depicting a horizontal section of half the core.

The core 1 of the sodium-cooled metal fuel fast reactor as depicted in FIG. 1 is configured from an inner core fuel region loaded with inner core fuel assemblies 2, an outer core fuel region surrounding the inner core fuel region and loaded with outer core fuel assemblies 3, a radial blanket fuel region surrounding the outer core fuel region and loaded with radial blanket fuel assemblies 4, reflector assemblies 5 further surrounding the radial blanket fuel region, and control rod assemblies 6 arranged in the inner and outer core fuel regions.

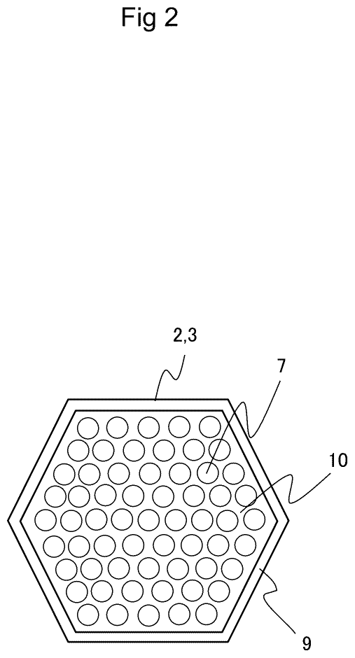

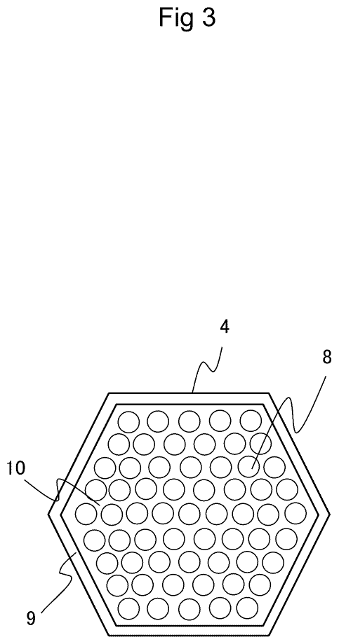

Horizontal cross-sectional views of the inner core fuel assembly 2 or the outer core fuel assembly 3 and the radial blanket fuel assembly 4 in this Example are presented in FIGS. 2 and 3, respectively.

The inner core fuel assembly 2 or the outer core fuel assembly 3 depicted in FIG. 2 is configured by tightly packing core fuel assembly fuel rods 7, which contain a U—Pu-MA-Zr alloy, in a triangular pitch array inside of a hexagonal wrapper tube 9 made from stainless steel.

Regions between the core fuel assembly fuel rods 7 themselves inside of the wrapper tube 9 are filled up with coolant sodium 10 flowing upstream from below the inner core fuel assemblies 2 and the outer core fuel assemblies 3. Pitches between the inner core fuel assemblies 2 or the outer core fuel assemblies 3 themselves is, for example, 161.4 mm, a cladding tube of each core fuel assembly fuel rod 7 has a diameter of 7.4 mm, and the enclosed core fuel assembly fuel rod 7 has a diameter of 5.5 mm.

Although simplified in the figure, each of the inner core fuel assembly 2 and the outer core fuel assembly 3 includes the core fuel assembly fuel rods 7 of 217.

The Pu enrichment of the metal fuel U—Pu-MA-Zr alloy in the core fuel assemblies is 20.8 wt % in the inner core fuel assemblies 2, and 25.0 wt % in the outer core fuel assemblies 3. The MA enrichment is 5 wt % in both the inner core fuel assemblies 2 and the outer core fuel assemblies 3.

On the other hand, the radial blanket fuel assembly 4 depicted in FIG. 3 has substantially the same horizontal cross-sectional specifications as the above-described inner core fuel assembly 2 and the outer core fuel assembly 3, but as will be mentioned below, is different in fuel enrichments and a height-direction fuel configuration.

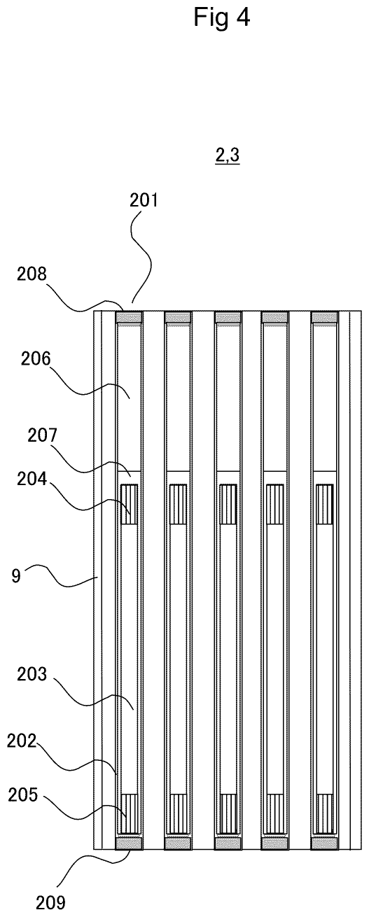

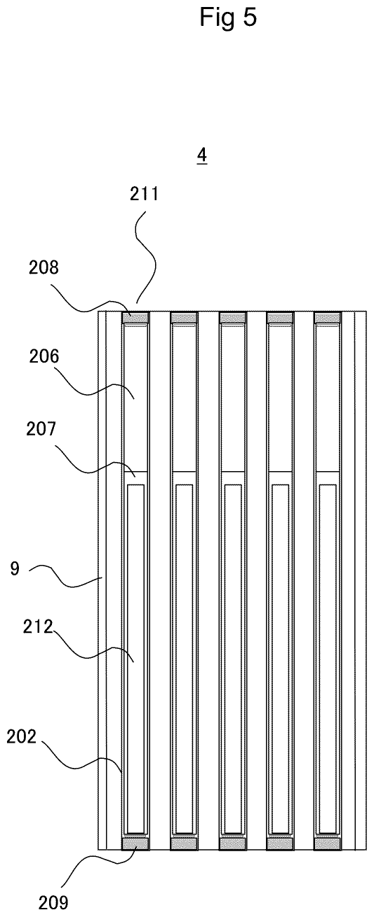

Configurations of the fuel assemblies in a height direction will be described using FIGS. 4 and 5. FIG. 4 is a longitudinal cross-sectional view of the core fuel assembly, and FIG. 5 is a longitudinal cross-sectional view of the radial blanket fuel assembly.

In each fuel rod 201 depicted in FIG. 4 and loaded in the inner core fuel assembly 2 or the outer core fuel assembly 3, a core fuel 203 with a cylindrical U—Pu-MA-Zr alloy filled therein, an upper axial blanket fuel 204 with a U—Pu-MA-Zr alloy of a low Pu enrichment filled therein, and a lower axial blanket fuel 205 with the U—Pu-MA-Zr alloy of the low Pu enrichment filled therein are enclosed inside of a cylindrical fuel cladding tube 202 made from stainless steel, with the core fuel 203, the upper axial blanket fuel 204, and the lower axial blanket fuel 205 being dipped in liquid bond sodium 207, a gas plenum 206 is formed above the fuels to hold gaseous fission products (FPs) therein, and an upper end plug 208 and a lower end plug 209 are welded to encase the fuels.

If desired to increase the nuclear transmutation amount of MA by loading MA in the blanket fuel region of a MOX fuel core, (U, MA) O₂, which is a mixed oxide of U and MA, is generally used as a blanket fuel. In the case of a metal fuel, however, it is not possible to produce a stable fuel for nuclear reactors by mixing only U and MA together.

In this Example, a U—Pu-MA-Zr alloy of a low Pu enrichment lower in Pu enrichment than the core fuel 203 is therefore used as the upper axial blanket fuel 204 and the lower axial blanket fuel 205 in the above-described inner core fuel assembly 2 and the outer core fuel assembly 3. From the viewpoint of fuel production, it is also necessary for the MA enrichment and the Pu enrichment to satisfy a relationship of 0 wt %<MA enrichment≤ Pu enrichment.

For example, the core fuel 203 has a length of 1000 mm in the longitudinal direction, and the upper axial blanket fuel 204 and the lower axial blanket fuel 205 each have a length of 200 mm in the longitudinal direction. The fuel rod 201 is hence 1400 mm long in total.

On the other hand, the radial blanket fuel assembly 4 depicted in FIGS. 3 and 5 is basically substantially the same in configuration and dimensions as the inner core fuel assembly 2 and the outer core fuel assembly 3, and the radial blanket fuel assembly fuel rods 8 depicted in FIGS. 3 and 5 are basically substantially the same in principal configuration and dimensions as the core fuel assembly fuel rods 7. They are however different as will hereinafter be described.

In each fuel rod 211 depicted in FIG. 5, a radial blanket fuel 212 uses a U—Pu-MA-Zr alloy of a low Pu enrichment lower in Pu enrichment than the core fuel 203 as in the above-described upper axial blanket fuel 204 and the lower axial blanket fuel 205. Moreover, from the viewpoint of fuel production, it is necessary for the MA enrichment and the Pu enrichment to satisfy the relationship of 0 wt %<MA enrichment≤ Pu enrichment.

The radial blanket fuel 212 has a length of 1400 mm in the longitudinal direction, which is the total length of each core fuel 203, the upper axial blanket fuel 204, and the lower axial blanket fuel 205 in the inner core fuel assembly 2 or the outer core fuel assembly 3.

For example, the U—Pu-MA-Zr alloy used as the upper and lower axial blanket fuels in the inner core fuel assembly 2 and the outer core fuel assembly 3 in FIG. 2 and the U—Pu-MA-Zr alloy used as the radial blanket fuel in the radial blanket fuel assembly 4 in FIG. 3 are both have a MA enrichment of 10 wt %, and a Pu enrichment of 13 wt %.

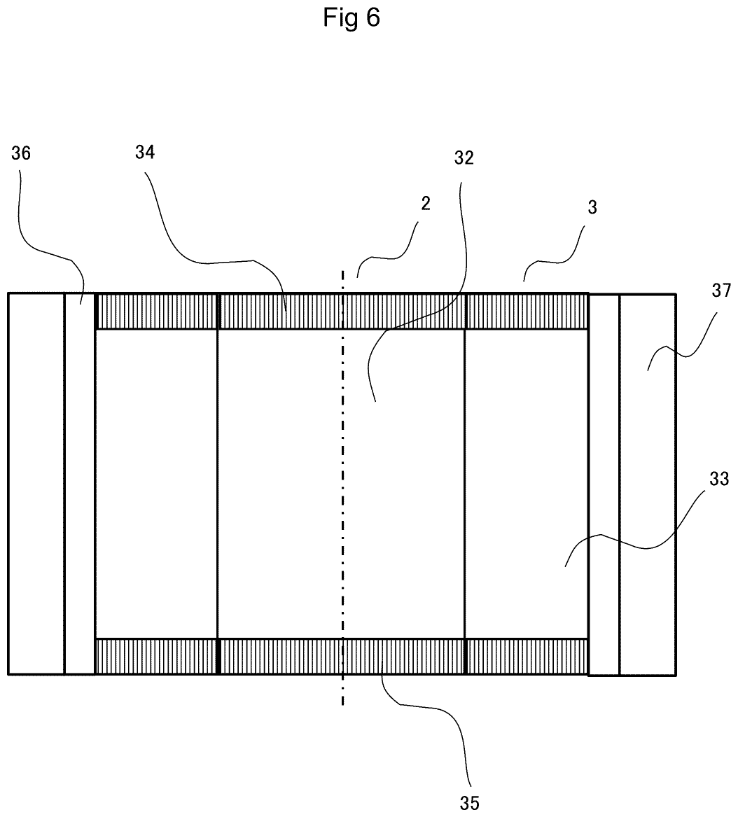

A longitudinal cross-section of the reactor core 1 is depicted in FIG. 6. As depicted in FIG. 6, the inner or outer core fuel regions are configured from an inner core fuel region 32 and an outer core fuel region 33, an upper axial blanket fuel region 34, and a lower axial blanket fuel region 35. Further, an outer core fuel region on a peripheral side is configured from a radial blanket fuel region 36 surrounding the core fuel region, and a reflector region 37 further surrounding the radial blanket fuel region 36.

Of these regions, the upper axial blanket fuel region 34, the lower axial blanket fuel region 35, and the radial blanket fuel region 36 use the U—Pu-Ma-Zr alloy of the low Pu enrichment lower in Pu enrichment than the core fuel. Moreover, from the viewpoint of fuel production, it is also necessary for the Ma enrichment and the Pu enrichment to satisfy the relationship of 0 wt %<MA enrichment≤ Pu enrichment.

The metal fuel fast reactor in this Example has, for example, an electrical power output of 311 MWe, and a thermal power output of 840 MW. The core fuel has a discharged average core fuel burnup of approximately 100 GWd/t.

In general, void reactivity increases by neutron spectrum hardening, fast fission effect of MA nuclides, and the like in a fast reactor, when MA is loaded in the core fuel region. However, the axial blanket fuel region and the radial blanket fuel region around the core are regions having negative void reactivity due to large neutron leakage.

In this Example where MA is also loaded in the respective regions of the upper axial blanket fuel 204, the lower axial blanket fuel 205, and the radial blanket fuel 212 in addition to the inner and outer core fuel regions, the void reactivity is 7 dollars as in a metal fuel core in which a MA-added U—Pu-MA-Zr alloy having an enrichment of 5 wt % is loaded in only the inner and outer core fuel regions, and is of a value lower than the design limit.

The nuclear transmutation amount of MA in the metal fuel core in this Example can be increased to approximately 140 kg/GWe-Y, 1.8 times as much as approximately 80 kg/GWe-Y which is the nuclear transmutation amount of MA when MA is added to an enrichment of 5 wt % to only the inner and outer core fuel regions.

Specifications of the core fuel assemblies are presented in Table 1.

TABLE 1

| Parameter | Unit | Specification |
|---|---|---|
| Fuel assembly pitch | mm | 161.4 |
| Outer surface to outer surface | mm | 157.1 |
| distance of fuel assembly | | |
| Wrapper tube wall thickness | mm | 3.9 |
| Number of fuel rods | — | 217 |
| Fuel rod cladding tube diameter | mm | 7.4 |
| Cladding tube wall thickness | mm | 0.5 |
| Metal fuel diameter | mm | 5.5 |
| Fuel smear density in fuel rod | % TD | 75 |
| cladding tubes | | |

A description will next be made in brief about the manufacturing method of the inner core fuel assemblies 2, the outer core fuel assemblies 3, and the radial blanket fuel assemblies 4 for the sodium-cooled metal fuel fast reactor that use the metal fuel according to this Example.

The manufacturing method of the fuel assemblies in this Example is characterized in that one or more of the upper axial blanket fuel 204 and the lower axial blanket fuel 205 in the inner core fuel assemblies 2 and the outer core fuel assemblies 3 and the radial blanket fuel 212 in the radial blanket fuel assemblies 4 are manufactured using the U—Pu-MA-Zr alloy of the low Pu enrichment lower in Pu enrichment than the core fuel so as to allow the MA enrichment and the Pu enrichment to satisfy the relationship of 0 wt %<MA enrichment≤ Pu enrichment. Concerning other configurations, other materials and their production methods, and the like, known techniques are adopted.

A description will next be made about effects of this Example.

Among the inner core fuel assemblies 2, the outer core fuel assemblies 3, and the radial blanket fuel assemblies 4 for the sodium-cooled metal fuel fast reactor that use the above-mentioned metal fuel of Example 1 of the present invention, one or more of the upper axial blanket fuel 204 and the lower axial blanket fuel 205 in the inner core fuel assemblies 2 and the outer core fuel assemblies 3 and the radial blanket fuel 212 in the radial blanket fuel assemblies 4 are the U—Pu-MA-Zr alloy of the low Pu enrichment lower in Pu enrichment than the core fuel, and the MA enrichment and the Pu enrichment satisfy the relationship of 0 wt %<MA enrichment≤ Pu enrichment.

Compared with the addition of Ma to only the core fuel, more MA can therefore be loaded without increasing the void activity, thereby enabling to increase the nuclear transmutation amount of MA in comparison with the conventional techniques.

### Example 2

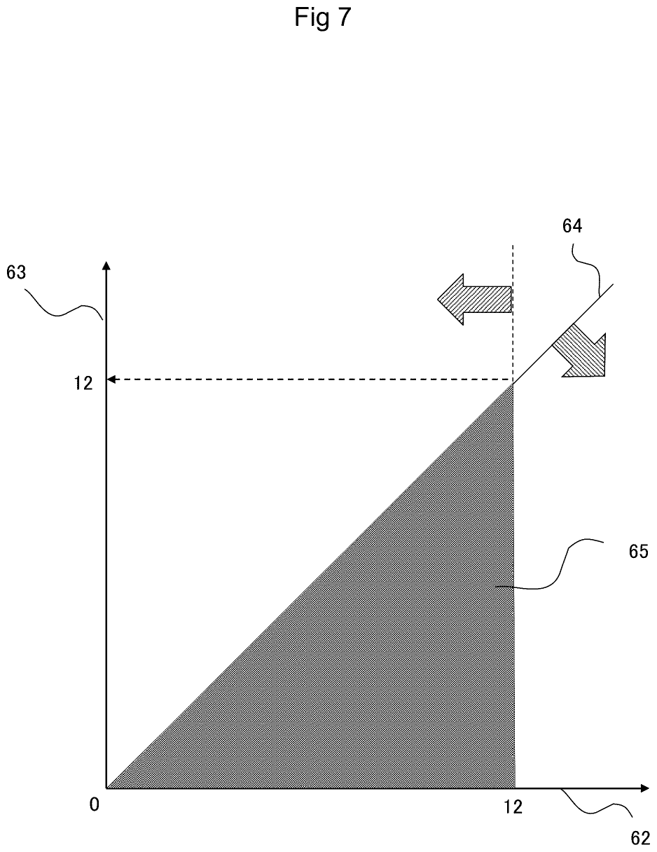

Fuel assemblies for the sodium-cooled metal fuel fast reactor, a reactor core, and a manufacturing method of the fuel assemblies, all in Example 2, will be described using FIG. 7.

In this Example, except for the values of a Pu enrichment and a MA enrichment of a U—Pu-MA-Zr alloy used as the upper axial blanket fuel 204, the lower axial blanket fuel 205, and the radial blanket fuel 212, specifications such as the configuration and the dimensions of the core and the fuel assemblies are the same as those of the fast reactor of Example 1.

FIG. 7 is a diagram illustrating a relationship between a Pu enrichment 62 and a MA enrichment 63 of the U—Pu-MA-Zr alloy used as the axial and radial blanket fuels in the core of the metal fuel fast reactor described in Example 1.

In FIG. 7, a straight line 64 represents a straight line with a gradient of 45°, on which the Pu enrichment and the MA enrichment are the same. A region in which U—Pu-MA-Zr alloys can be produced is a region below the straight line 64, where MA enrichment≤ Pu enrichment.

Assuming, as the fuel composition of transuranium elements (TRU), a fuel composition represented by the below-described formula (1) when it is recycled multiple times in a metal fuel core, using standard computational methods for fast reactors in Japan, and also using a nuclear data set for fast reactors based on the widely recognized nuclear data library JENDL-4.0, Pu enrichment conditions for allowing to create more Pu than consumed, in other words, to achieve an internal conversion ratio greater than 1 in the axial and radial blanket regions described in Example 1 were determined through a core analysis.

$$Pu 238 / Pu 239 / Pu 240 / Pu 241 / Pu 242 / Np 237 / Am 241 / Am 243 / \qquad ( 1 )$$

$$Cm 244 / Cm 245 = 1.1 / 66. / 25.2 / 2.4 / 2.4 / 0.4 / 1.6 / 0.5 / 0.4 / 0.1 wt \%$$

As a result, the internal conversion ratio has been found to exceed 1 when the Pu enrichment is 12 wt % or lower.

In order to allow the breeding ratio of the core of the metal fuel fast reactor described in Example 1 to exceed 1 and hence to allow fuel breeding, it is necessary for the Pu enrichment and the MA enrichment to fall in a triangular area indicated by a region 65 in FIG. 7, in other words, to have a relationship represented by a formula (2).

0 wt %<MA enrichment≤Pu enrichment≤12 wt % (2)

Now assume that as in Example 1, the Pu enrichment of the inner core fuel is 20.8 wt %, the Pu enrichment of the outer core fuel is 25.0 wt %, and the MA enrichments of the inner and outer core fuels are both 5 wt %. If the MA enrichment and the Pu enrichment satisfy the conditions of the formula (2), specifically the MA enrichment is 5 wt %, which is the same as in the core fuel, and the Pu enrichment is also 5 wt %, which is the same as the MA enrichment, in the U—Pu-MA-Zr alloy as the upper and lower axial blanket fuels in the core fuel assemblies and the radial blanket fuel in the radial blanket fuel assemblies, the nuclear transmutation amount of MA is 96 kg/GWe-Y and is reduced to approximately 1.2 times the nuclear transmutation amount of MA available if MA is added to the enrichment of 5 wt. % to only the core fuel region, but the breeding ratio of the core exceeds 1, and fuel breeding is possible.

Other configurations and operations are substantially the same as in the above-mentioned fuel assemblies for the sodium-cooled metal fuel fast reactor, the reactor core, and the manufacturing method of the fuel assemblies in Example 1, and their details are omitted.

In the fuel assemblies for the sodium-cooled metal fuel fast reactor, the reactor core, and the manufacturing method of the fuel assemblies in Example 2 of the present invention, substantially similar effects as in the above-mentioned fuel assemblies for the sodium-cooled metal fuel fast reactor, the reactor core, and the manufacturing method of the fuel assemblies in Example 1 are obtained.

### Example 3

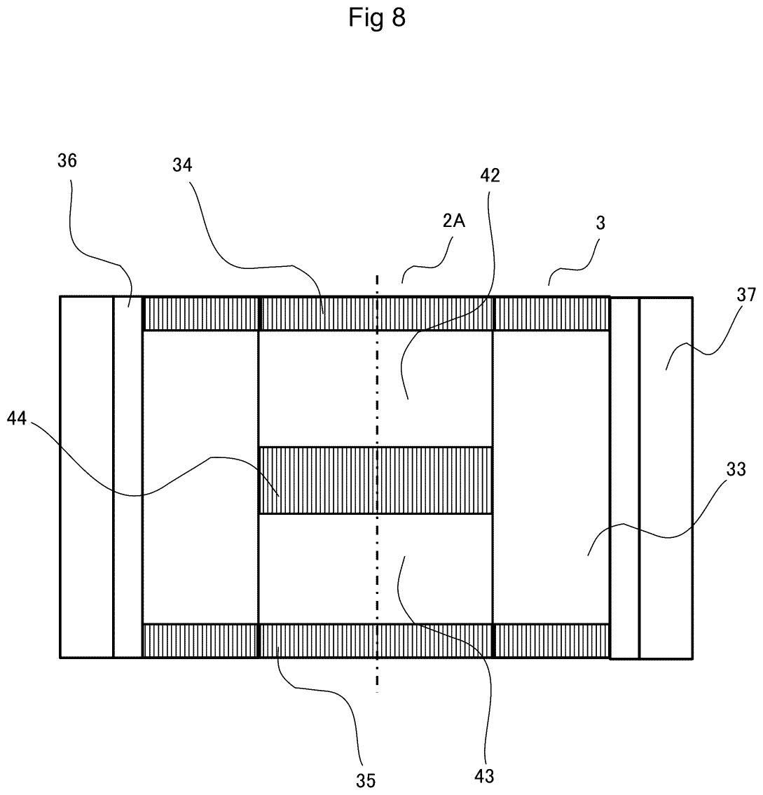

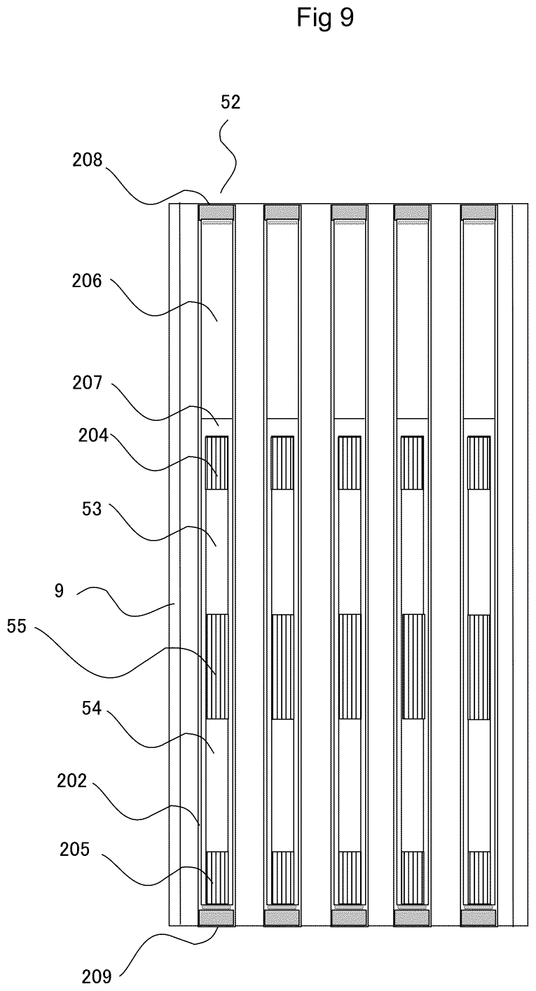

Fuel assemblies for the sodium-cooled metal fuel fast reactor, a reactor core, and a manufacturing method of the fuel assemblies, all in Example 3, will be described using FIGS. 8 and 9. FIG. 8 is a view depicting a longitudinal cross-section of the core of this Example, and FIG. 9 is a view depicting a longitudinal cross-section of an inner core fuel assembly.

From the core of the metal fuel fast reactor of Example 1 as depicted in FIG. 6, the core of this Example as depicted in FIG. 8 is different in the configuration of an axially non-homogeneous core that an inner blanket fuel region 44 is arranged in a height-direction central region of an inner core fuel assembly 2A. Except for the foregoing difference, specifically an upper inner core fuel region 42 and a lower inner core fuel region 43 are substantially the same as the inner core fuel region 32.

As depicted in FIG. 9, in each fuel rod 52 of each inner core fuel assembly 2A, an upper core fuel 53 and lower core fuel 54 with a U—Pu-MA-Zr alloy filled in a cylindrical shape therein, an inner blanket fuel 55 with a U—Pu-MA-Zr alloy of a low Pu enrichment filled therein and located between the upper core fuel 53 and the lower core fuel 54, an upper axial blanket fuel 204, and a lower axial blanket fuel 205 are enclosed inside of a cylindrical fuel cladding tube 202 made from stainless steel, with the upper core fuel 53, the lower core fuel 54, the inner blanket fuel 55, the upper axial blanket fuel 204, and the lower axial blanket fuel 205 being dipped in liquid bond sodium 207, a gas plenum 206 is formed above the fuels to hold gaseous FPs therein, and an upper end plug 208 and a lower end plug 209 are welded to encase the fuels.

As the upper axial blanket fuel 204 and the lower axial blanket fuel 205, U—Pu-MA-Zr alloys are used. As in Example 1, their MA enrichments are both 10 wt %, and their Pu enrichments are both 13 wt %.

Further, the inner blanket fuel 55 is the U—Pu-MA-Zr alloy, the MA enrichment and the Pu enrichment of which satisfy the relationship of 0 wt %<MA enrichment≤ Pu enrichment. For example, a U—Pu-MA-Zr alloy of a low Pu enrichment is used, the Pu enrichment and the MA enrichment are equally 5 wt %, and the length in the longitudinal direction is 200 mm. The upper core fuel 53 and the lower core fuel 54 are the U—Pu-MA-Zr alloy, the Pu enrichment and the MA enrichment of which are 25.0 wt % and 5 wt %, respectively, and their heights in the vertical direction are both 400 mm.

Other configurations and operations are substantially the same as in the above-mentioned fuel assemblies for the sodium-cooled metal fuel fast reactor, the reactor core, and the manufacturing method of the fuel assemblies in Example 1, and their details are omitted.

In the fuel assemblies for the sodium-cooled metal fuel fast reactor, the reactor core, and the manufacturing method of the fuel assemblies in Example 3 of the present invention, substantially similar effects as in the above-mentioned fuel assemblies for the sodium-cooled metal fuel fast reactor, the reactor core, and the manufacturing method of the fuel assemblies in Example 1 are obtained.

Owing to the use of the inner blanket fuel 55, which is the U—Pu-MA-Zr alloy of the MA enrichment and the Pu enrichment satisfying the relationship of 0 wt %<MA enrichment≤ Pu enrichment, in the axial center region of each inner core fuel assembly 2A, the loaded amount of MA in the core is not different, and the nuclear transmutation amount of MA is the same as in Example 1. Owing to the arrangement of the inner blanket fuel having the low Pu enrichment of 5 wt % in the axial central region of the inner core fuel, the power peaking and the maximum burnup rate in the axial direction are suppressed, the margin for fuel integrity is increased, and the burnup reactivity is reduced by approximately 20%, all compared with those of the core of the metal fuel fast reactor of Example 1, so that the safety margin in an unprotected transient over power (UTOP) event is increased.

### Others

The present invention should not be limited to the above-described Examples, and includes various modifications. The above Examples are described in detail to facilitate understanding of the present invention, so that the present invention should not be necessarily limited to those including all the described elements.

Further, a part of the elements of one Example can be replaced for the similar or corresponding element or elements of another Example, and a part of the elements of one Example can also be added to the elements of another Example. Furthermore, with respect to a part of the elements of each Example, their omission and/or replacement, and/or addition of one or more other elements can be also made.

In the above Examples, sodium is used as a coolant, for example. Use of lead or lead-bismuth can also achieve similar effects.

Further, the metal fuels are used as fuels. Similar effects are also available from use of MOX fuels or nitride fuels.

Furthermore, similar effects are also available from desired combinations of the individual coolants and the individual fuels described above.

### DESCRIPTION OF REFERENCE CHARACTERS

1: Reactor core
2, 2A: Inner core fuel assembly
3: Outer core fuel assembly
4: Radial blanket fuel assembly
5: Reflector assembly
6: Control rod assembly
7: Core fuel assembly fuel rod
8: Radial blanket fuel assembly fuel rod
9: Wrapper tube
10: Coolant sodium
32: Inner core fuel region
33: Outer core fuel region
34: Upper axial blanket fuel region
35: Lower axial blanket fuel region
36: Radial blanket fuel region
37: Reflector region
42: Upper inner core fuel region
43: Lower inner core fuel region
44: Inner blanket fuel region
52: Fuel rod
53: Upper core fuel
54: Lower core fuel
55: Inner blanket fuel
62: Pu enrichment
63: MA enrichment
64: Straight line on which Pu enrichment becomes the same as
MA enrichment
65: Region indicating a range in which MA-containing metal fuels can be produced to allow fuel breeding
201: Fuel rod
202: Fuel cladding tube
203: Core fuel
204: Upper axial blanket fuel
205: Lower axial blanket fuel
206: Gas plenum
207: Bond sodium
208: Upper end plug
209: Lower end plug
211: Fuel rod
212: Radial blanket fuel

What is claimed is:

1. A core fuel assembly or a radial blanket fuel assembly among fuel assemblies for a sodium-cooled fast reactor using a metal fuel, wherein
one or more of an axial blanket fuel in the core fuel assembly or a radial blanket fuel in the radial blanket fuel assembly is a U—Pu-MA-Zr alloy of a low Pu enrichment lower in Pu enrichment than a core fuel, and has a MA enrichment and a Pu enrichment satisfying a relationship of 0 wt %<MA enrichment≤ Pu enrichment.

2. The fuel assembly according to claim 1, wherein
the MA enrichment and the Pu enrichment of one or more of the axial blanket fuel or the radial blanket fuel satisfy a relationship of 0 wt %<MA enrichment≤ Pu enrichment≤12 wt %.

3. The fuel assembly according to claim 1, wherein
an inner blanket fuel that is the U—Pu-MA-Zr alloy and has the MA enrichment and the Pu enrichment satisfying the relationship of 0 wt %<MA enrichment≤ Pu enrichment is used in an axial central region of an inner core fuel assembly as the core fuel assembly.

4. A core of a sodium-cooled metal fuel fast reactor, loaded with the fuel assembly according to claim 1.

5. A manufacturing method of a fuel assembly for a sodium-cooled fast reactor using metal fuel, comprising:
producing an axial blanket fuel in one or more of a core fuel assembly or a radial blanket fuel in a radial blanket fuel assembly by using a U—Pu-MA-Zr alloy of a low Pu enrichment lower in Pu enrichment than a core fuel, such that the axial blanket fuel or the radial blanket fuel has a MA enrichment and a Pu enrichment satisfying a relationship of 0 wt %<MA enrichment≤ Pu enrichment.
